(19) United States
(12) Patent Application Publication
(10) Pub. No.: US 2013/0206168 A1
(43) Pub. Date: Aug. 15, 2013

(54) APPARATUSES AND METHODS FOR SCRUBBING SUBSTRATES

(71) Applicants: Thomas West, Portola Valley, CA (US); Stephen Kirtley, Saratoga, CA (US); Matt Richardson, Milpitas, CA (US); Ken Ponder, Soquel, CA (US); John Tocchini, Tracy, CA (US); Long Nguyen, San Jose, CA (US)

(72) Inventors: Thomas West, Portola Valley, CA (US); Stephen Kirtley, Saratoga, CA (US); Matt Richardson, Milpitas, CA (US); Ken Ponder, Soquel, CA (US); John Tocchini, Tracy, CA (US); Long Nguyen, San Jose, CA (US)

(73) Assignee: THOMAS WEST, INC., Sunnyvale, CA (US)

(21) Appl. No.: 13/698,647

(22) PCT Filed: May 19, 2011
(86) PCT No.: PCT/US11/37074

§ 371 Date: Jan. 31, 2013

Related U.S. Application Data
(60) Provisional application No. 61/346,461, filed on May 19, 2010.

(51) Int. Cl. B08B 1/00

(52) U.S. Cl. CPC B08B 1/006
USPC 134/6; 15/230; 15/244.4; 15/104.94; 29/895.213

(57) ABSTRACT

One aspect of the present invention includes an apparatus for scrubbing substrates such as a roller scrubber. According to one embodiment, the apparatus comprises a scrubbing medium having an axial bore and a mandrel having a section disposed through the axial bore of the scrubbing medium. The mandrel is configured so that it exerts an adjustable axial compression on the scrubbing medium. According to another embodiment, the apparatus comprises a roller scrubber. The roller scrubber comprises a scrubbing medium comprising a plurality of discrete disks having a center hole. The disks are disposed side by side so that the center holes form an axial bore in the scrubbing medium. The combined outer edges of the plurality of disks form a scrubbing surface of the roller scrubber.

### CROSS REFERENCES

This application claims benefit of U.S. Patent Application Ser. No. 61/346,461, Docket No. TWI-050, titled “TUNABLE ROLLER SCRUBBER,” to Thomas WEST et al., filed May 19, 2010 and International Application No. PCT/US2011/037074, titled “APPARATUSES AND METHODS FOR SCRUBBING SUBSTRATES,” to Thomas WEST et al., filed May 19, 2011. The content of U.S. Patent Application Ser. No. 61/346,461, filed May 19, 2010, and the content of International Application No. PCT/US2011/37074, filed May 19, 2011, are incorporated herein, in their entirety, by this reference for all purposes.

### BACKGROUND

During the manufacture of items such as rigid disk substrates for thin film magnetic media, silicon wafers, patterned wafers for semiconductor devices, reticles for micro lithography, flat panel displays, optics and other such work pieces requiring precise surface finishing, polishing methods employing abrasives are used to produce the required surface. After polishing, it is important to remove residual abrasive particles, remaining effluent of the abraded surface, debris from polishing pad material, airborne dust particles, and/or other surface contaminants from the polished surface. Stringent methods and materials are employed to provide a clean surface substantially free of contaminants. Typically, commercially available automated cleaning systems are used and most systems include a contact cleaning method employing rollers which scrub the surface of the substrate being cleaned. One example system is described in U.S. Pat. No. 7,516,507.

Cleaning criticality increases with higher density devices. As cleaning criticality has increased, contact cleaning systems have evolved to have multiple cleaning steps. Where one scrubbing station might have sufficed previously, five or more might be employed today.

Polyvinyl acetal (PVA) foam rollers are commonly used for contact cleaning steps within most automated cleaning systems. One of the advantages that made PVA the roller material of choice is its high porosity which facilitates high flow of purified water or cleaning chemistries through the roller and onto the surface being cleaned. This provides required fluids to the point of use and flushes the PVA roller from the inside out thereby reducing the build-up of contaminants onto the roller. PVA can be molded into various roller constructions required to fit the particular cleaning system and can incorporate surface features which may enhance cleaning. The porosity and density of PVA foam influence properties such as fluid flow, roller stiffness and elasticity and resistance to wear from usage. U.S. Pat. No. 4,566,911 and US Patent Application Publication 2008/0141475 describe PVA roller technologies.

### SUMMARY

One aspect of the present invention includes an apparatus for scrubbing substrates such as a roller scrubber. According to one embodiment, the apparatus comprises a scrubbing medium having an axial bore and a mandrel having a section disposed through the axial bore of the scrubbing medium. The mandrel is configured so that it exerts an adjustable axial compression on the scrubbing medium. According to another embodiment, the apparatus comprises a roller scrubber. The roller scrubber comprises a scrubbing medium comprising a plurality of discrete disks having a center hole. The disks are disposed side by side so that the center holes form an axial bore in the scrubbing medium. The combined outer edges of the plurality of disks form a scrubbing surface of the roller scrubber.

Another aspect of the present invention includes methods of cleaning substrates. According to one embodiment, the method includes steps that use apparatuses according to one or more embodiments of the present invention.

Still another aspect of the present invention includes methods of constructing a roller scrubber. According to one embodiment, the method comprises providing a plurality of disks of scrubbing medium, the disks have a center hole, and providing a flow-through mandrel having a first flange, washer, and/or nut proximate one end and a second flange, washer, and/or nut proximate the opposite end. The method further includes stacking the plurality of disks onto the flow through mandrel between the first flange, washer, and/or nut and the second flange, washer, and/or nut so that the mandrel is disposed through the center holes of the plurality of disks. The combined outer edges of the plurality of disks form a scrubbing surface.

It is to be understood that embodiments of the invention are not limited to the details of construction and to the arrangements of the components set forth in the following description. Embodiments of the invention can be practiced and carried out in various ways. In addition, it is to be understood that the phraseology and terminology employed herein are for the purpose of description and should not be regarded as limiting.

### BRIEF DESCRIPTION OF THE DRAWINGS

FIG. 1 is a block diagram of one or more embodiments of the present invention.

FIG. 2 is a side view of one or more embodiments of the present invention.

FIG. 3 is a cross-section side view of one or more embodiments of the present invention.

FIG. 4 is a cross-section side view of one or more embodiments of the present invention.

FIG. 5 is a side view of one or more embodiments of the present invention.

FIG. 6 is a cross-section side view of one or more embodiments of the present invention.

FIG. 7 is a cross-section side view of one or more embodiments of the present invention.

FIG. 8 is a side view of one or more embodiments of the present invention.

FIG. 9 is a side view of one or more embodiments of the present invention.

FIG. 10 is a perspective view of one or more embodiments of the present invention.

FIG. 11-1 is a side view of one or more embodiments of the present invention.

FIG. 11-2 is a side view of one or more embodiments of the present invention.

FIG. 11-3 is a side view of one or more embodiments of the present invention.

FIG. 12-1 is a side view of one or more embodiments of the present invention.

FIG. 12-2 is a side view of one or more embodiments of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DESCRIPTION

For the following defined terms, these definitions shall be applied, unless a different definition is given in the claims or elsewhere in this specification. All numeric values are herein defined as being modified by the term “about,” whether or not explicitly indicated. The term “about” generally refers to a range of numbers that a person of ordinary skill in the art would consider equivalent to the stated value to produce substantially the same properties, function, result, etc. A numerical range indicated by a low value and a high value is defined to include all numbers subsumed within the numerical range and all subranges subsumed within the numerical range. As an example, the range 10 to 15 includes, but is not limited to, 10, 10.1, 10.47, 11, 11.75 to 12.2, 12.5, 13 to 13.8, 14, 14.025, and 15.

One or more aspects of the present invention pertain to processing substrates such as substrates for thin film magnetic media, silicon wafers, patterned wafers for semiconductor devices, reticles for micro lithography, flat panel displays, optics and other such work pieces requiring precise surface finishing and cleaning.

The operation of embodiments of the present invention may be discussed below, primarily in the context of processing semiconductor wafers such as silicon wafers used for fabricating integrated circuits. More particularly, the discussion may be directed toward cleaning substrates using apparatuses and materials for scrubbing substrates. However, it is to be understood that embodiments in accordance with the present invention may be used for other types of substrates, other types of devices, other types of applications, and/or for processes other than scrubbing.

The inventors have made studies of methods for providing more aggressive cleaning than that possible with conventional roller scrubbers for cleaning substrates. The inventors have found that previous designs failed to provide adequate longevity of use due to construction integrity weaknesses and premature loading of contaminants onto the cleaning material. One or more embodiments of the present invention eliminate use of seams or bonding agents in the scrubbing medium thereby resolving wear issues of earlier designs. Furthermore, shortened longevity of scrubbing mediums due to contaminant loading is substantially eliminated in one or more embodiments of the present invention by including configurations that allow ample fluid flow through the scrubbing medium.

Another deficiency in alternative technologies is that roller stiffness cannot be adjusted by the user. One or more embodiments of the present invention comprise methods and materials for adjusting scrubber medium stiffness and fluid flow through the roller scrubber. Stiffness and fluid flow are critical process parameters in substrate cleaning processes. One or more embodiments of present invention are configured so as to provide the flexibility to employ a wide range of different materials for the scrubbing medium. According to one or more embodiments of the present invention, the scrubbing medium is comprised of die-cut disks of material so as to allow for rapid fabrication of roller scrubbers without the design limitations, longer fabrication cycles, and high costs associated with molded components typically used.

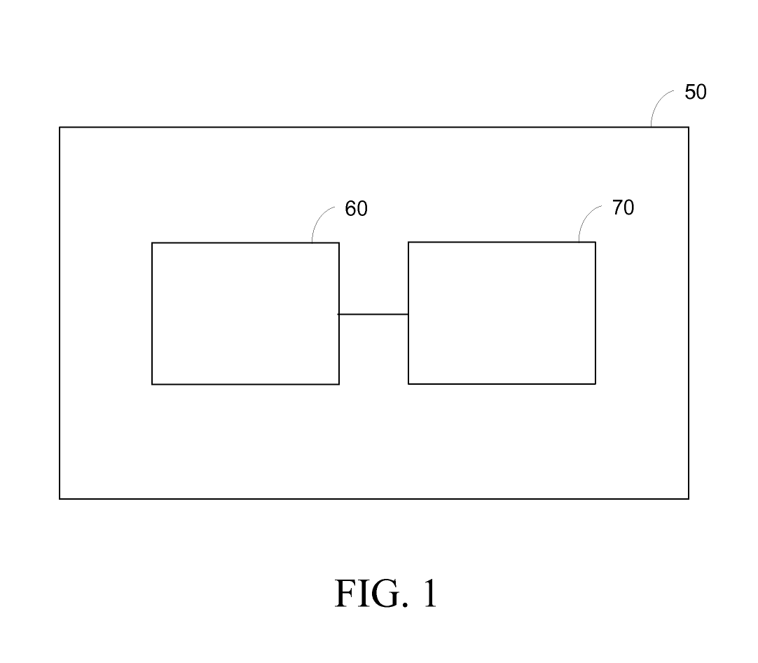

Reference is now made to FIG. 1 where there is shown a block diagram of an apparatus 50 for processing substrates according to one or more embodiments of the present invention. Apparatus 50 comprises a scrubbing medium 60 and a mandrel 70 or other means for holding scrubber medium 60. Scrubbing medium 60 and mandrel 70 are coupled so that mandrel 70 provides physical support for scrubbing medium 60. According to one or more embodiments, mandrel 70 is configured to provide rotation for the scrubbing medium for configurations such as a roller scrubber.

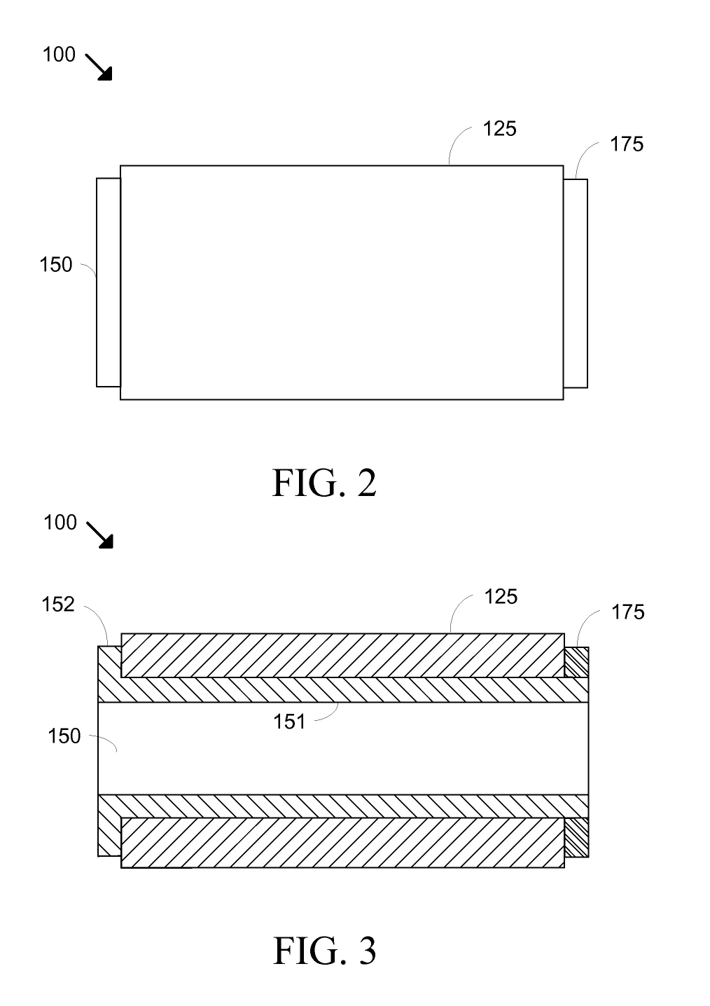

Reference is now made to FIG. 2 and FIG. 3 where there is shown a scrubber 100 according to one or more embodiments of the present invention. FIG. 2 shows a side view of scrubber 100; FIG. 3 shows a cross-section side view of scrubber 100. Scrubber 100 comprises a scrubbing medium 125 that is substantially cylindrical in shape and has an axial bore. Scrubber 100 also comprises a mandrel 150 having a section 151 disposed through the axial bore of scrubbing medium 125. Mandrel 150 is configured so that it exerts an adjustable axial compression on scrubbing medium 125 sufficient so as to modify at least one scrubbing property of scrubbing medium 125 such as the stiffness and/or the elasticity of scrubbing medium 125. The axial compression is a compressive force applied to the ends of the scrubbing medium. The axial compression is substantially parallel to the axis of the scrubbing medium.

The amount of the axial compression that is used will be partially dependent on the properties of the scrubbing medium. For one or more embodiments of the present invention, example ranges for the axial compression applied to the ends of the scrubbing medium include, but are not limited to, greater than 0 pounds per square inch (0 Pa) to about 5 pounds per square inch (34,475 Pa) including all values and sub ranges subsumed therein and from about 0.25 pounds per square inch (1724 Pa) to about 1.5 pounds per square inch (10,343 Pa) including all values and sub ranges subsumed therein.

Mandrel 150 may have a variety of configurations to produce the adjustable axial compression. As an option, mandrel 150 may comprise a clamping mechanism to force the ends of scrubbing medium 125 together to produce the adjustable axial compression. For the embodiment shown in FIG. 2 and FIG. 3, mandrel 150 has a flange 152 on one end and at least one flange, washer and/or nut 175 coupled to the opposite end. The at least one flange, washer, and/or nut 175 is coupled to section 151 so that the spacing between flange 152 and the at least one flange, washer, and/or nut 175 can be reduced or increased to produce the adjustable axial compression. According to one or more embodiments of the present invention, flange 152 and the at least one flange, washer, and/or nut 175 have outer diameters greater than the diameter of the axial bore of scrubbing medium 125. In other words, the dimensions of flange 152 and the dimensions of the at least one flange, washer, and/or nut 175 are selected so as to apply the adjustable axial compression to all or portions of the ends of scrubbing medium 125. Flange 152 and the at least one flange, washer, and/or nut 175 can be selected to have diameter, thickness, and material type that provides a selected amount of axial compression and/or selected amount of support applied to scrubbing medium 125. According to one or more embodiments of the present invention, flange 152 and the at least one flange, washer, and/or nut 175 have outer diameters greater than the diameter of the axial bore of scrubbing medium 125 and less than the outer diameter of scrubbing medium 125.

According to one or more embodiments of the present invention, increases in the axial compression on scrubbing medium 125 increases the stiffness of scrubbing medium 125. According to one or more embodiments of the present invention, the axial compression on the scrubbing medium is provided so that it is sufficient to increase the stiffness of the scrubbing medium to accomplish increased scrubbing effectiveness for scrubber 100.

Scrubbing medium 125 may comprise a variety of materials. Examples of some materials that may be used for scrubbing medium 125 include, but are not limited to, nonwoven felt, impregnated nonwoven fabric, and open cell foam. According to one or more embodiments of the present invention, scrubbing medium 125 comprises fluid permeable material. Another material that may be used for scrubbing medium 125 is polyvinyl acetal foam.

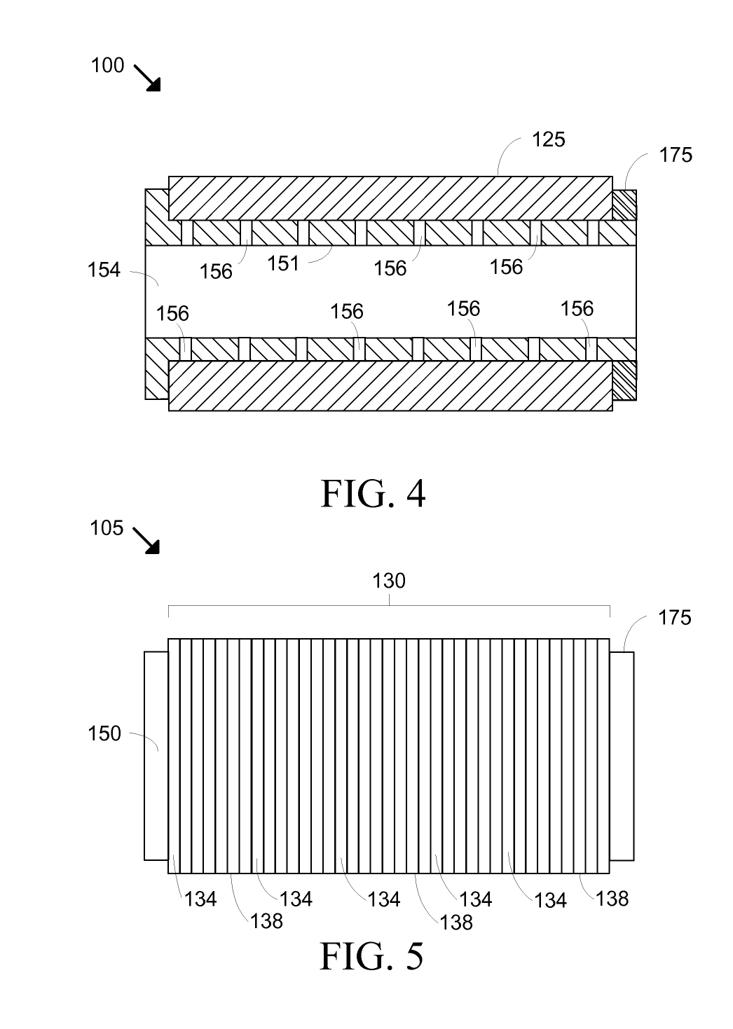

Reference is now made to FIG. 4 where there is shown a cross-section side view of a scrubber 100 according to one or more embodiments of the present invention. Scrubber 100 comprises a scrubbing medium 125 substantially as described above. Scrubber 100 also comprises a mandrel 154 that is substantially the same as mandrel 150 described above with the exception that mandrel 154 is also configured as a flow through mandrel. More specifically, mandrel 154 has a substantially hollow interior capable of conveying fluids. The walls of mandrel 154 have one or more holes 156 and/or other openings to distribute fluid to the axial bore of scrubbing medium 125. Mandrel 154 is configured to apply an adjustable axial compression to the scrubbing medium 125 such as by using a clamping mechanism. FIG. 4 shows scrubber 100 having at least one flange, washer, and/or nut 175 coupled to apply the adjustable axial compression.

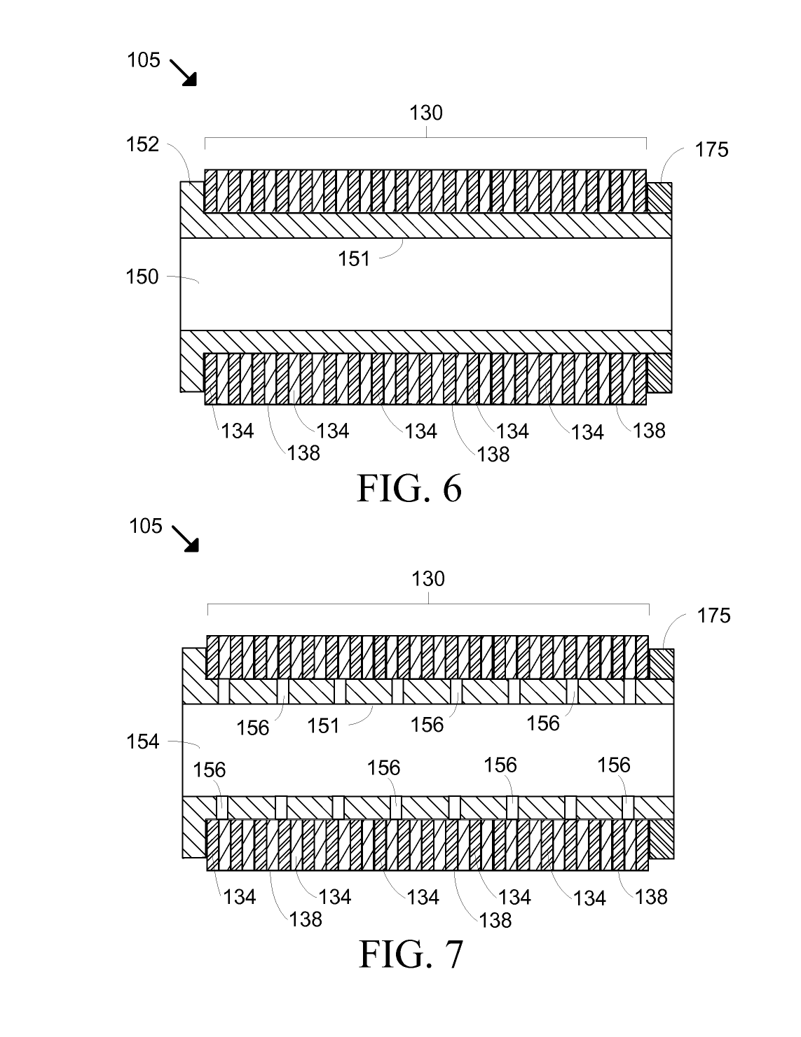

Reference is now made to FIG. 5 and FIG. 6 where there is shown a scrubber 105 according to one or more embodiments of the present invention. FIG. 5 shows a side view of scrubber 105; FIG. 6 shows a cross-section side view of scrubber 105. Scrubber 105 comprises a scrubbing medium 130 and a mandrel 150. Scrubbing medium 130 is substantially cylindrical in shape and has an axial bore. Scrubbing medium 130 comprises a plurality of discrete disks 134 placed side by side. Each discrete disk 134 is a separate unit and has a center hole. The combined center holes of the discrete disks 134 form the axial bore of scrubbing medium 130. The combined outer edges 138 of the plurality of disks 134 form a scrubbing surface of scrubber 105.

Mandrel 150 has a section 151 disposed through the axial bore of scrubbing medium 130. Mandrel 150 has a flange 152 and at least one flange, washer, and/or nut 175. Flange 152 and the at least one flange, washer, and/or nut 175 can be selected to have diameter, thicknesses, and material type that provides a selected amount of axial compression and/or selected amount of support provided to scrubbing medium 130, more specifically, the plurality of disks 134. According to one or more embodiments of the present invention, the plurality of disks 134 have substantially equal inside diameters and substantially equal outside diameters. As an option for one or more embodiments of the present invention, the plurality of disks has substantially equal thicknesses.

Discrete disks 134 may comprise a variety of materials. Examples of some materials that may be used for disks 134 include, but are not limited to, nonwoven felt, impregnated nonwoven fabric, and open cell foam. According to one or more embodiments of the present invention, disks 134 comprise fluid permeable material. Another material suitable for disks 134 is polyvinyl acetal foam. As an option, disks 134 comprise polyester, nylon, rayon, cotton, polyurethane, polyethylene, or combinations thereof. According to one or more embodiments of the present invention, disks 134 may comprise substantially non-permeable materials. In one or more embodiments of the present invention, disks 134 comprise closed cell foam or solid elastomers.

Reference is now made to FIG. 7 where there is shown a cross-section side view of a scrubber 105 according to one or more embodiments of the present invention. Scrubber 105 comprises a scrubbing medium 130 substantially as described above. Scrubber 105 also comprises a mandrel configured as a flow through mandrel that is substantially the same as mandrel 154 described above. More specifically, mandrel 154 has a substantially hollow interior capable of conveying fluids. The walls of mandrel 154 have one or more holes 156 and/or other openings to distribute fluid to the axial bore of scrubbing medium 130. Mandrel 154 is configured to apply an adjustable axial compression to the ends of scrubbing medium 130 such as by using a clamping mechanism. Mandrel 154 has a flange 152. FIG. 7 shows scrubber 105 having at least one flange, washer, and/or nut 175 coupled to apply the adjustable axial compression by changing the distance between flange 152 and the at least one flange, washer, and/or nut 175.

Consequently, one or more embodiments of the present invention enables a user to modify the stiffness, elasticity, fluid flow through, and/or other properties of the scrubber by adjusting the axial compression. The modifications of the stiffness and/or other properties are substantially reversible. This means that the scrubber stiffness can be change from one state to another and back again to essentially the original stiffness. The modifications can be made after the scrubbing medium is installed and can be adjusted for optimization of scrubbing effectiveness.

The amount of the axial compression that is used will be partially dependent on the properties of the scrubbing medium. For one or more embodiments of the present invention, example ranges for the axial compression applied to the ends of the scrubbing medium comprising a plurality of disks include, but are not limited to, greater than 0 pounds per square inch (0 Pa) to about 5 pounds per square inch (34,475 Pa) including all values and sub ranges subsumed therein and from about 0.25 pounds per square inch (1724 Pa) to about 1.5 pounds per square inch (10,343 Pa) including all values and sub ranges subsumed therein.

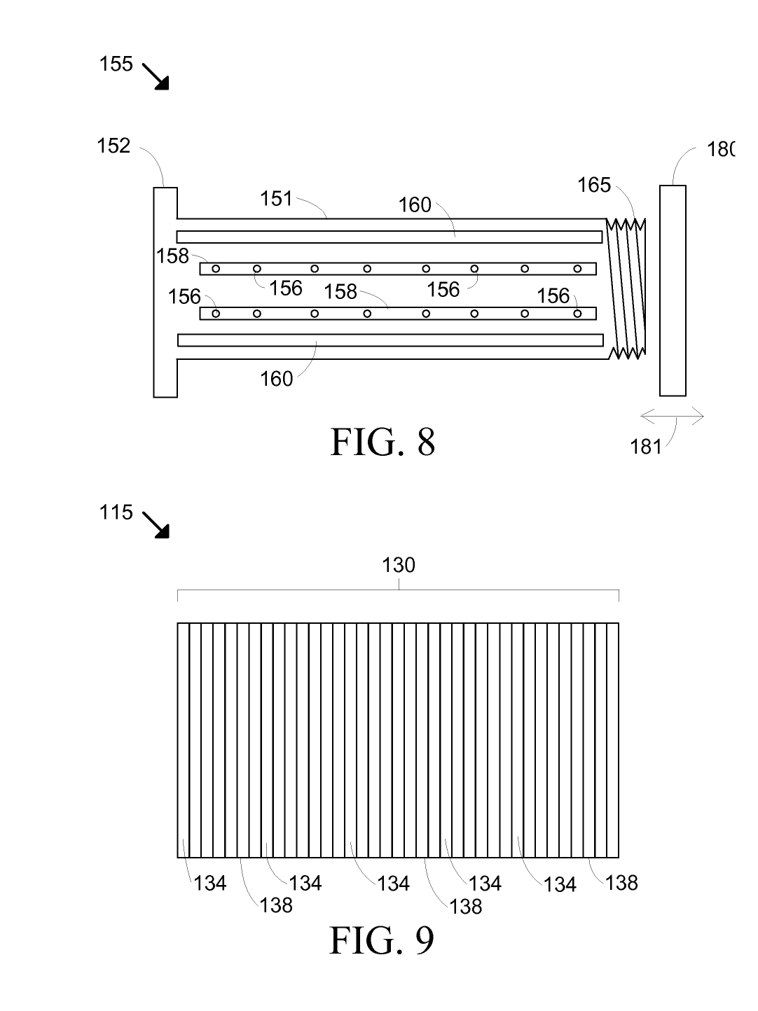

Reference is now made to FIG. 8 where there is shown a side view of a flow through mandrel 155 according to one or more embodiments of the present invention. Mandrel 155 as a middle section 151 that can be disposed through an axial bore of a scrubbing medium. Mandrel 155 has a substantially hollow interior capable of conveying fluids. The walls of mandrel 155 have one or more holes 156 and/or other openings to distribute fluid to the axial bore of the scrubbing medium. Mandrel 155 is configured to apply an adjustable axial compression to the ends of the scrubbing medium such as by using a clamping mechanism. Mandrel 155 comprises at least one flange such as flange 152 and/or at least one washer that can be coupled to the scrubbing medium. For the embodiment shown in FIG. 8, mandrel 155 has threads 165 for making threaded couplings. Mandrel 155 further comprises at least one washer and/or threadably coupled nut 180 and/or at least one threadably coupled screw or bolt disposed so as to urge the at least one flange such as flange 152 and the at least one washer and/or threadably coupled nut 180 toward the scrubbing medium so as to exert the adjustable axial compression on the scrubbing medium. FIG. 8 shows the at least one washer and/or threadably coupled nut 180 detached from mandrel 155 for illustration purposes. An arrow 181 is included in FIG. 8 to show the direction of motion for attaching and adjusting the position of the at least one washer and/or threadably coupled nut 180. In other words, the adjustable axial compression is accomplished by changing the distance between flange 152 and the at least one flange, washer, and/or nut 180 with the scrubbing medium therebetween.

As an option for one or more embodiments of the present invention, mandrel 155 has one or more fluid flow channels 158 formed in the outer surface of middle section 151 for distribution of fluid along the axial bore of the scrubbing medium. Fluid flow channel 158 is in fluid communication with holes 156. Fluid flow channel 158 and holes 156 are disposed so as to accomplish a more even distribution of fluid from the interior of mandrel 155.

As an option for one or more embodiments of the present invention, mandrel 155 is configured so as to substantially prevent slippage between the mandrel and the scrubbing medium when the scrubbing medium is being rotated by the mandrel. Optionally, the outer sidewall of middle section 151 of mandrel 155 may be configured with one or more raised structures and/or grooves designed to fit with or receive complementary features formed on the surface of the axial bore of the scrubbing medium. The embodiment shown in FIG. 8 shows mandrel 155 having one or more grooves 160 or other structure for receiving features such as tabs that may be formed on the inside surface of the scrubbing medium. Disks of scrubbing material having tabs may be aligned into grooves 160 or other structures in the mandrel thereby indexing the disks to the mandrel. According to one or more embodiments of the present invention, grooves 160 and the tabs are configured so that the relative rotation position of the disks on mandrel 155 can be selected.

In view of the present disclosure, persons of ordinary skill in the art will understand that a variety of combinations of flanges, washers, nuts, bolts, and/or other mechanical devices and configurations can be used to accomplish the axial compression of the scrubbing medium for mandrels according to one or more embodiments of the present invention. As examples: multiple washers can be used, multiple nuts can be used, a variety of types of washers can be used, a variety of types of nuts can be used, set screws can be used, and or combinations thereof. Also, persons of ordinary skill in the art will recognize that numerous alternative designs can be use as replacements for the functions of the tabs and grooves as described above such as, but not limited to, using matching polygon shapes, keyed mandrel and matching notch in the disk, etc. can be used.

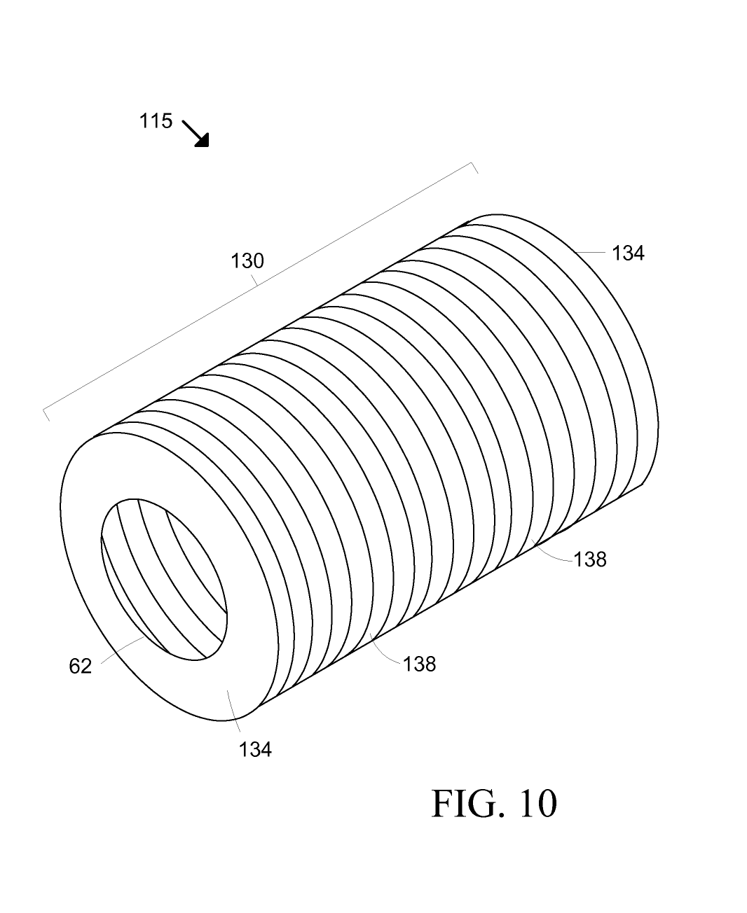

Reference is now made to FIG. 9 and FIG. 10 where there is shown a roller scrubber 115 for substrates according to one or more embodiments of the present invention. FIG. 9 shows a side view of scrubber 115. FIG. 10 shows a perspective view of scrubber 115. Roller scrubber 115 comprises a scrubbing medium 130 that comprises a plurality of discrete disks 134 having a center hole 62. Disks 134 are disposed side by side so that center holes 62 form an axial bore in scrubbing medium 130. The outer edges 138 of disks 134 are disposed so that the combined outer edges of the plurality of disks 134 form a scrubbing surface of the roller scrubber 115.

Roller scrubber 115 may further comprise a flow-through mandrel (not shown in FIG. 9 and FIG. 10) disposed through the axial bore of scrubbing medium 130. Optionally, the mandrel may be configured to exert sufficient axial compression on scrubbing medium 130 so as to alter the stiffness of scrubbing medium 130 and/or alter the fluid flow through properties of the scrubbing medium 130 to substantially optimize substrate scrubbing.

According to one or more other embodiments of the present invention, the mandrel does not exert sufficient force on scrubbing medium 130 to significantly alter the stiffness of scrubbing medium 130 and/or to significantly alter the fluid flow through properties of the scrubbing medium 130.

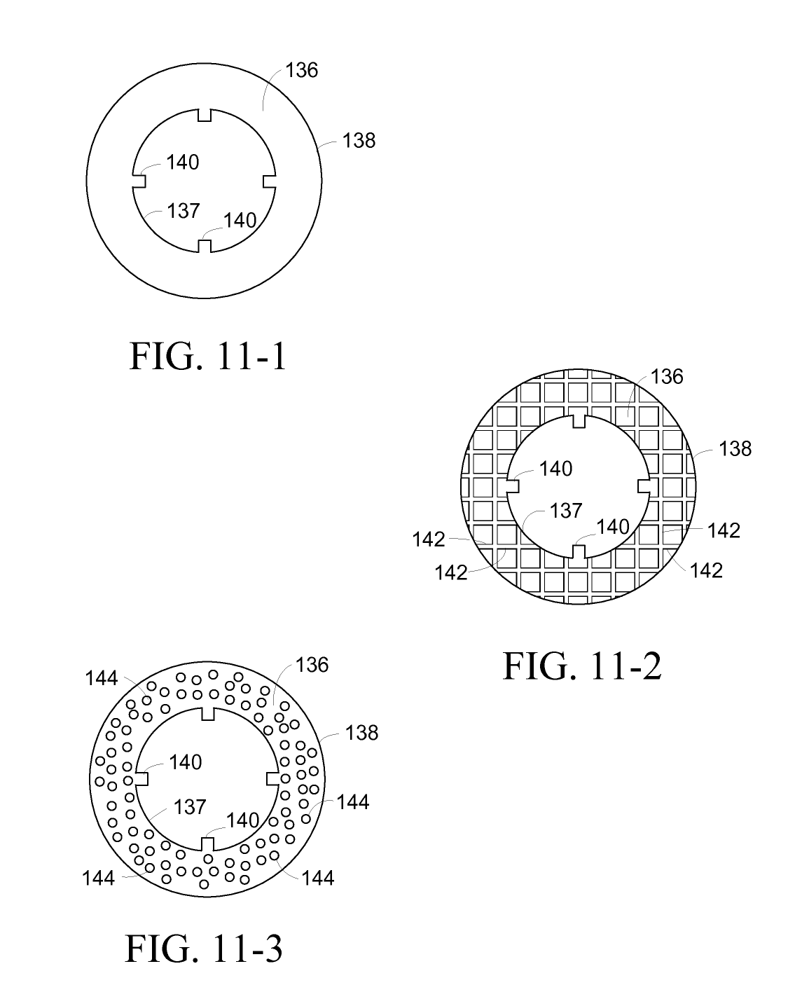

Embodiments of the present invention such as those illustrated in FIG. 5, FIG. 6, FIG. 7, FIG. 9, and FIG. 10 and described above may include a variety of configurations of discrete disks for the scrubbing medium. Reference is now made to FIG. 11-1 where there is shown a side view of a disk 136 according to one or more embodiments of the present invention. Disk 136 has a center hole 137. The center hole 137 is shaped so that disk 136 has one or more tabs 140 for holding disk 136 to a mandrel to prevent slippage and/or for indexing the position of disk 136 around the mandrel. Disk 136 has an outer edge 138.

Reference is now made to FIG. 11-2 where there is shown a side view of a disk 136 according to one or more embodiments of the present invention. Disk 136 has a center hole 137. The center hole 137 is shaped so that disk 136 has one or more tabs 140 for holding disk 136 to a mandrel to prevent slippage and/or for indexing the position of disk 136 around the mandrel. Disk 136 has an outer edge 138.

Also, disk 136 has one or more features or patterns such as geometric patterns formed on one or both side surfaces so as to modify fluid flow characteristics and/or stiffness of disk 136 and the scrubbing medium in which it is used. More specifically, the features or patterns are configured to produce increased fluid flow between disks 136 to the scrubbing interface of the roller scrubber. Additional modifications to the side surface of the disks can be selected to further optimize the disks to a particular cleaning application. The depth, pattern, and density of surface modifications can be varied to adjust and direct fluid flow. The shape, size density, and location of features or patterns can be varied to adjust and direct fluid flow and alter the stiffness characteristics of the disk.

Structural properties such as stiffness, elasticity, fluid flow through properties of the disk and the scrubbing medium to which it contributes can be adjusted by the dimensions of and types of features or patterns on the surfaces of disk 136. For the embodiment shown in FIG. 11-2, the surface of disk 136 has an x-y pattern of grooves formed thereon so as to modify fluid flow characteristics and/or stiffness.

Reference is now made to FIG. 11-3 where there is shown a side view of a disk 136 according to one or more embodiments of the present invention. Disk 136 has a center hole 137. The center hole 137 is shaped so that disk 136 has one or more tabs 140 for holding disk 136 to a mandrel to prevent slippage and/or for indexing the position of disk 136 around the mandrel. Disk 136 has an outer edge 138. Also, disk 136 has one or more perforations so as to modify fluid flow characteristics and/or stiffness of the disk 136. Structural properties such as stiffness, elasticity, fluid flow through properties of the disk and the scrubbing medium to which it contributes can be adjusted by the dimensions of and arrangement of the one or more perforations through the surface of disk 136. In this embodiment, the fluid permeability of the disk will be increased thereby delivering more fluid flow to the cleaning interface and the stiffness of the disk will be reduced.

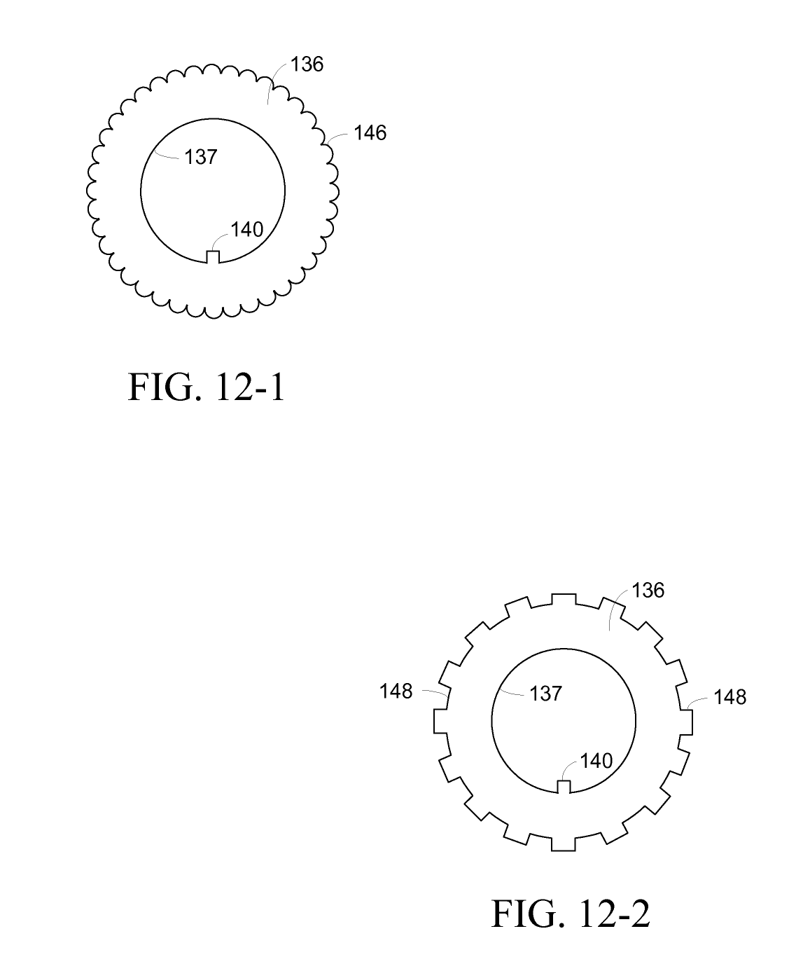

Reference is now made to FIG. 12-1 where there is shown a side view of a disk 136 according to one or more embodiments of the present invention. Disk 136 has a center hole 137. The center hole 137 is shaped so that disk 136 has one or more tabs for holding disk 136 to a mandrel to prevent slippage and/or for indexing the position of disk 136 around the mandrel. Disk 136 has a patterned outer edge 146 patterned with one or more structural features formed thereon. The embodiment shown in FIG. 12-1 has a scalloped pattern for patterned outer edge 146. Patterns for the scrubbing surface to which patterned outer edge 146 contributes can be modified by selecting the relative rotational positions of disk 136 with respect to adjacent disk 136. For example, the scrubbing surface can be modified by a user so as to have channels by aligning the recessed sections of patterned outer edge 146 of the disk 136. As another example, the scrubbing surface can be modified by a user so as to have open pockets by offsetting the recessed sections of patterned outer edge 146 of the disk 136. Yet another example, the scrubbing surface can be modified by a user so as to have a combination of pockets and grooves as a result of the selectable alignment of adjacent disk 136. Disk 136 can be optionally aligned to give the scrubbing surface a continuous pattern or intentionally offset to give the scrubbing surface an alternating pattern.

Reference is now made to FIG. 12-2 where there is shown a side view of a disk 136 according to one or more embodiments of the present invention. Disk 136 shown in FIG. 12-2 is essentially the same as disk 136 shown in FIG. 12-1 with the exception that the patterned outer edge 146 has features shaped as polygons.

Additional embodiments of the present invention may include a scrubbing medium comprising disk having other configurations. As examples, the disk may be configured so that they have 2 or more combinations of the characteristics described for the disks shown in FIGS. 11-2, 11-3, 12-1, and 12-2. Disk may be configured so that they have patterned side surfaces, perforations through the disk, patterned outer edges, and/or combinations thereof.

According to one or more embodiments of the present invention, each discrete disk has a thickness in the range from about 0.8 millimeter to about 2 millimeters and all values and ranges subsumed therein. According to one or more other embodiments of the present invention, each discrete disk has a thickness in the range from about 0.5 millimeter to about 13 millimeters and all values and ranges subsumed therein. In view of the present disclosure, other thicknesses for the disks will be clear to persons of ordinary skill in the art.

One or more embodiments of the present invention enable a user to modify the pattern of a roller scrubber surface. The modifications of the pattern are substantially reversible. This means that the pattern for the scrubber surface can be change from one pattern to another and back again if desired. The modifications can be made even after the scrubbing medium has been used and the pattern can be adjusted for optimization of scrubbing effectiveness. The modifications can be accomplished using indexing tabs to fix the relative rotational position of adjacent disks on a mandrel configured to accommodate the positioning of the indexing tabs.

Another aspect of the present invention includes a method of scrubbing substrates using a system or apparatus that includes embodiments of the present invention presented in FIGS. 1 through 10, 11-1, 11-2, 11-3, 12-1, and/or 12-2 and described above. According to one or more embodiments of the present invention, the method comprises adjusting the axial compression applied to the scrubbing medium so that the stiffness of the scrubbing medium becomes substantially optimized for removing contaminants from the substrates; scrubbing one or more substrates; measuring the effectiveness of the scrubbing of the substrates; and re-adjusting the axial compression if the scrubbing effectiveness decreases.

Another a method of scrubbing substrates using a system or apparatus that includes embodiments of the present invention presented in FIGS. 1 through 10, 11-1, 11-2, 11-3, 12-1, and/or 12-2 and described above comprises adjusting the axial compression applied to the scrubbing medium so that the stiffness of the scrubbing medium becomes substantially optimized for removing contaminants from the substrates; scrubbing one or more substrates; re-adjusting the axial compression applied to the scrubbing medium so that stiffness of the scrubbing medium and/or fluid flow through properties of the scrubbing medium become substantially optimized for removing another type of contaminant; and scrubbing one or more substrates.

Another aspect of the present invention includes a method of constructing a roller scrubber for scrubbing substrates. According to one or more embodiments of the present invention, the method comprises providing a plurality of disks of scrubbing medium, the disks having a center hole. The method comprises providing a flow-through mandrel having a first flange, washer, and/or nut proximate one end and a second flange, washer, and/or nut proximate the opposite end. The method further comprises stacking the plurality of disks onto the flow through mandrel between the first flange, washer, and/or nut and the second flange, washer, and/or nut so that the mandrel is disposed through the center holes of the plurality of disks and the combined outer edges of the plurality of disks form a scrubbing surface.

Optionally, the method may also comprise exerting and holding axial compression on the plurality of disks using the first flange, washer, and/or nut and the second flange, washer, and/or nut so that the stiffness of the scrubbing surface is increased above that for the scrubbing surface without the axial compression. According to one or more embodiments of the present invention, the amount of compression of the stack of disk is adjusted by adding one or more disks or by removing one or more disks.

The method of constructing the roller scrubber according to one or more embodiments of the present invention may include one or more of the following optional steps: Modifying fluid flow characteristics and/or stiffness of the disks by modifying surface geometry of the disks or perforating the disks. Modifying fluid flow characteristics and/or stiffness of the disks by forming a pattern of grooves into one or both surfaces of the disk. Modifying fluid flow characteristics and/or stiffness of the disks by forming an x-y pattern of grooves into one or both surfaces of the disk. Modifying fluid flow characteristics and/or stiffness of the disks by forming perforations through the surface of the disks. Modifying the profile of the outer edge of the disks to provide surface structure so that the relative positioning of adjacent disks on the mandrel provides adjustable geometries on the scrubber surface. Modifying the profile of the outer edge of the disks to provide a scalloped pattern or polygon patterns and aligning the disks so that the scrubbing surface comprises a continuous pattern or intentionally offsetting the disks to form an alternating pattern. Adjusting the axial compression by keeping the quantity of disks fixed and adjusting the distance between two support washers, flanges, and/or nuts. Adjusting the axial compression by varying the quantity of disks or by using spacers that take up space between two support washers, flanges, and/or nuts.

In the foregoing specification, the invention has been described with reference to specific embodiments. However, one of ordinary skill in the art appreciates that various modifications and changes can be made without departing from the scope of the present invention as set forth in the claims below. Accordingly, the specification is to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” “includes,” “including,” “has,” “having,” “at least one of,” or any other variation thereof, are intended to cover a non-exclusive inclusion. For example, a process, method, article, or apparatus that comprises a list of elements is not necessarily limited only to those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. An apparatus for scrubbing substrates, the apparatus comprising:
a scrubbing medium having an axial bore;
a mandrel having a section disposed through the axial bore of the scrubbing medium, the mandrel being configured so that it exerts an adjustable axial compression on the scrubbing medium.

2. The apparatus of claim 1, wherein the mandrel comprises a clamping mechanism to exert the adjustable axial compression on the scrubbing medium.

3. The apparatus of claim 1, wherein the mandrel comprises at least one flange and/or at least one washer coupled to the scrubbing medium so as to exert the adjustable axial compression on the scrubbing medium.

4. The apparatus of claim 1, wherein the mandrel comprises at least one flange and/or at least one washer coupled to the scrubbing medium, and at least one threadably coupled nut and/or at least one threadably coupled screw or bolt disposed so as to urge the at least one flange and/or the at least one washer toward the scrubbing medium so as to exert the adjustable axial compression on the scrubbing medium.

5. The apparatus of claim 1, wherein the axial compression on the scrubbing medium is sufficient to increase the stiffness of the scrubbing medium to accomplish increased scrubbing effectiveness for the apparatus.

6. The apparatus of claim 1, wherein the scrubbing medium comprises nonwoven felt, impregnated nonwoven fabric, or open cell foam.

7. The apparatus of claim 1, wherein the scrubbing medium comprises polyvinyl acetal foam.

8. The apparatus of claim 1, wherein the scrubbing medium comprises a plurality of disks placed side by side, the disks have a center hole that forms the axial bore.

9. The apparatus of claim 8, wherein the disks have one or more tabs and the mandrel has at least one structure configured to receive the one or more tabs so as to prevent the disks from rotating independently from rotation of the mandrel.

10. The apparatus of claim 8, wherein the disks comprise fluid permeable material.

11. The apparatus of claim 8, wherein the disks comprise nonwoven felt, impregnated nonwoven fabric, or open cell foam.

12. The apparatus of claim 8, wherein the disks comprise polyvinyl acetal foam.

13. The apparatus of claim 8, wherein the disks comprise polyester, nylon, rayon, cotton, polyurethane, polyethylene, or combinations thereof.

14. The apparatus of claim 8, wherein the disks comprise substantially non-permeable materials.

15. The apparatus of claim 8, wherein the disks comprise closed cell foam or solid elastomers.

16. The apparatus of claim 8, wherein the surface of the disks has one or more patterns formed thereon so as to modify fluid flow characteristics and/or stiffness.

17. The apparatus of claim 8, wherein the surface of the disks has an x-y pattern of grooves formed thereon.

18. The apparatus of claim 8, wherein the surface of the disks have one or more perforations so as to modify fluid flow characteristics and/or stiffness.

19. The apparatus of claim 8, wherein the disks have an outer edge surface patterned with one or more structural patterns formed thereon so that the relative positioning of adjacent disks on the mandrel provides adjustable geometries on the scrubber surface.

20. The apparatus of claim 8, wherein the disks have an outer edge that has a scalloped pattern or polygon pattern so that the disk can be optionally aligned to give the scrubbing surface a continuous pattern or intentionally offset to give the scrubbing surface an alternating pattern.

21. A method of scrubbing substrates using the apparatus of claim 1, the method comprising:
adjusting the axial compression applied to the scrubbing medium so that the stiffness of the scrubbing medium becomes substantially optimized for removing contaminants from the substrates;
scrubbing one or more substrates;
measuring the effectiveness of the scrubbing of the substrates; and
re-adjusting the axial compression if the scrubbing effectiveness decreases.

22. A method of scrubbing substrates using the apparatus of claim 1, the method comprising:
adjusting the axial compression applied to the scrubbing medium so that the stiffness of the scrubbing medium becomes substantially optimized for removing contaminants from the substrates;
scrubbing one or more substrates;
re-adjusting the axial compression applied to the scrubbing medium so that stiffness of the scrubbing medium and/or fluid flow through the scrubbing medium become substantially optimized for removing another type of contaminant; and
scrubbing one or more substrates.

23. A roller scrubber for substrates, the roller scrubber comprising:
a scrubbing medium comprising a plurality of discrete disks having a center hole, the disks being disposed side by side so that the center holes form an axial bore in the scrubbing medium, wherein the combined outer edges of the plurality of disks form a scrubbing surface of the roller scrubber.

24. The roller scrubber of claim 23, further comprising a flow-through mandrel disposed through the axial bore of the scrubbing medium, the mandrel being configured to exert axial compression on the discrete disks so as to adjust the stiffness of the scrubbing medium and/or the fluid flow through properties of the scrubbing medium to substantially optimize substrate scrubbing.

25. The roller scrubber of claim 23, wherein the disks comprise fluid permeable material.

26. The roller scrubber of claim 23, wherein the disks comprises nonwoven felt, impregnated nonwoven fabric, or open cell foam.

27. The roller scrubber of claim 23, wherein the disks comprise polyvinyl acetal foam

28. The roller scrubber of claim 23, wherein the disks comprises polyester, nylon, rayon, cotton, polyurethane, polyethylene, or combinations thereof.

29. The roller scrubber of claim 23, wherein the disks comprises substantially non-permeable materials.

30. The roller scrubber of claim 23, wherein the disks comprise closed cell foam or solid elastomers.

31. The roller scrubber of claim 23, wherein the surface of the disks has one or more patterns formed thereon so as to modify fluid flow characteristics and/or stiffness of the disks.

32. The roller scrubber of claim 23, wherein the surface of the disks has an x-y pattern of grooves formed thereon so as to modify fluid flow characteristics and/or stiffness of the disks.

33. The roller scrubber of claim 23, wherein the surface of the disks have one or more perforations so as to modify fluid flow characteristics and/or stiffness of the disks.

34. The roller scrubber of claim 23, wherein the disks have an outer edge surface patterned with one or more structural patterns formed thereon so that the relative positioning of adjacent disks on the mandrel provides adjustable geometries on the scrubber surface.

35. The roller scrubber of claim 23, wherein the disks have an outer edge that has a scalloped pattern or polygon pattern so that the disk can be optionally aligned to give the scrubbing surface a continuous pattern or intentionally offset to give the scrubbing surface an alternating pattern.

36. A method of constructing a roller scrubber for scrubbing substrates, the method comprising:
providing a plurality of disks of scrubbing medium, the disks having a center hole;
providing a flow-through mandrel having a first flange, washer, and/or nut proximate one end and a second flange, washer, and/or nut proximate the opposite end;
stacking the plurality of disks onto the flow through mandrel between the first flange, washer, and/or nut and the second flange, washer, and/or nut so that the mandrel is disposed through the center holes of the plurality of disks and the combined outer edges of the plurality of disks form a scrubbing surface.

37. The method of claim 36, further comprising exerting and holding axial compression on the plurality of disks using the first flange, washer, and/or nut and the second flange, washer, and/or nut so that the stiffness of the scrubbing surface is increased.

38. The method of claim 37, wherein the amount of compression of the plurality of disks is adjusted by adding one or more disks or removing one or more disks.
